(19) United States
(12) Patent Application Publication
(10) Pub. No.: US 2011/0068588 A1
(43) Pub. Date: Mar. 24, 2011

(54) Draw latch with safety catch

(76) Inventor: Eduard Kopylov, Aurora, CO (US)

(21) Appl. No.: 12/807,869

(22) Filed: Sep. 9, 2009

(51) Int. Cl. E05C 3/14

(52) U.S. Cl. 292/200

(57) ABSTRACT

A draw latch 13 with a safety catch for fastening two members 11 and 12, where said latch comprises a base 16 attached to said member 12, a lever 17 pivotally connected to said base 16 for movement between closed and open positions, a draw bar 15 pivotally connected with one end to said lever 17 providing toggle action upon the latch lever 17 closing and another end of said draw bar 15 is for engagement with a draw plate 14 attached to said member 11. Said safety catch comprises a safety catch bolt 22 with thumb knob 21, where said bolt 21 is supported by a side wall of said lever 17 a support bracket 25 attached to said lever 17, said safety catch bolt 22 orientation is substantially parallel to the pivotal axis of said latch lever 17. A compression spring 26 being mounted on said safety catch bolt 22 forces said bolt into locked position to engage a latch base tab 23 and an engagement hole 28 on another wall of said latch lever 17 allowing said bold to protrude through this wall and preventing the latch to open. The safety catch can be open by pushing said knob 21 into the open position, so said safety catch bolt 22 will disengage allowing the lever 17 to be lifted to open the latch. Said latch draw bar can be designed to accommodate dimensional variations.

### CROSS-REFERENCE TO RELATED APPLICATIONS

Not Applicable

### FEDERALLY SPONSORED RESEARCH

Not Applicable

### SEQUENCE LISTING OF PROGRAM

Not Applicable

### BACKGROUND OF INVENTION

1Field of Invention

This invention relates generally to heavy duty, toggle type draw latches for connecting two relatively movable members.

Some of such latches, existing on the market, are equipped with safety locking means which are such like provisions for padlock installation, hook type catches, locks requiring keys, spring hooks, rotational locking cams are either expensive to manufacturer or not reliable in heavy duty applications.

The is need for a draw latch with simple, durable, reliable secondary catch with exposed engagement which will be able to operate reliably in heavy duty applications.

2. Prior Art

The Catch with Antirelease Latch by Gunnar E. Swanson in U.S. Pat. No. 3,602,723 Proposes hook type safety catch which engagement concealed within device, such arrangement does not offer positive control of the safety latch engagement and hook type catch is not reliable in heavy duty applications

The Adjustable Toggle Latch and Safety Catch offered by Schenk in U.S. Pat. No. 4,307,906 comprises the hook formed flat spring as the safety catch mounted on the latch and engaging the latch lever. The exposed spring element of this safety locking arrangement is prone to bending in heavy duty application.

The Toggle Latch with Spring Catch presented by Conrad Gunther in U.S. Pat. No. 4,352,513 comprises spring type safety catch which is prone to bending and does not offer observable engagement.

The Handle Operated Draw Latch with Safety Catch disclosed by Weinerman et al U.S. Pat. No. 5,445,422 comprises hook type safety catch with too many complicated parts increasing cost of manufacturing and reducing reliability of performance.

The Over-center Latch disclosed by Norman Evans in U.S. Pat. No. 6,840,551 comprises safety catch which is pivotally movable in and out of engaged Position offers observable engagement, however, it requires significant angular rotation and rotating Catch Member is a cantilever extending from the pivotal point and is prone to bend and jam.

### OBJECTS AND ADVANTAGES

Accordingly, besides the objects and advantages of the Toggle Latch described in my patent, several objects and advantages of the present invention are:
a. To provide a Draw Latch with simple, low manufacturing cost Safety Catch.
b. The Safety Catch shall be reliable and durable to withstand strong unlocking forces in heavy duty applications.
c. The Safety Catch shall have positive, observable engagement.
d. Action of the Safety catch shall be ergonomically convenient

### SUMMARY

The device of the present invention overcomes the above-mentioned disadvantages and drawbacks that are characteristic of these aforementioned designs. More particularly, a preferred embodiment of the present invention a draw toggle latch with the safety catch comprising spring loaded bolt with a thumb knob, where said bolt is linearly movable in locked and unlocked positions in direction substantially parallel to the Latch lever pivotal axis.

### DRAWINGS

### Figures

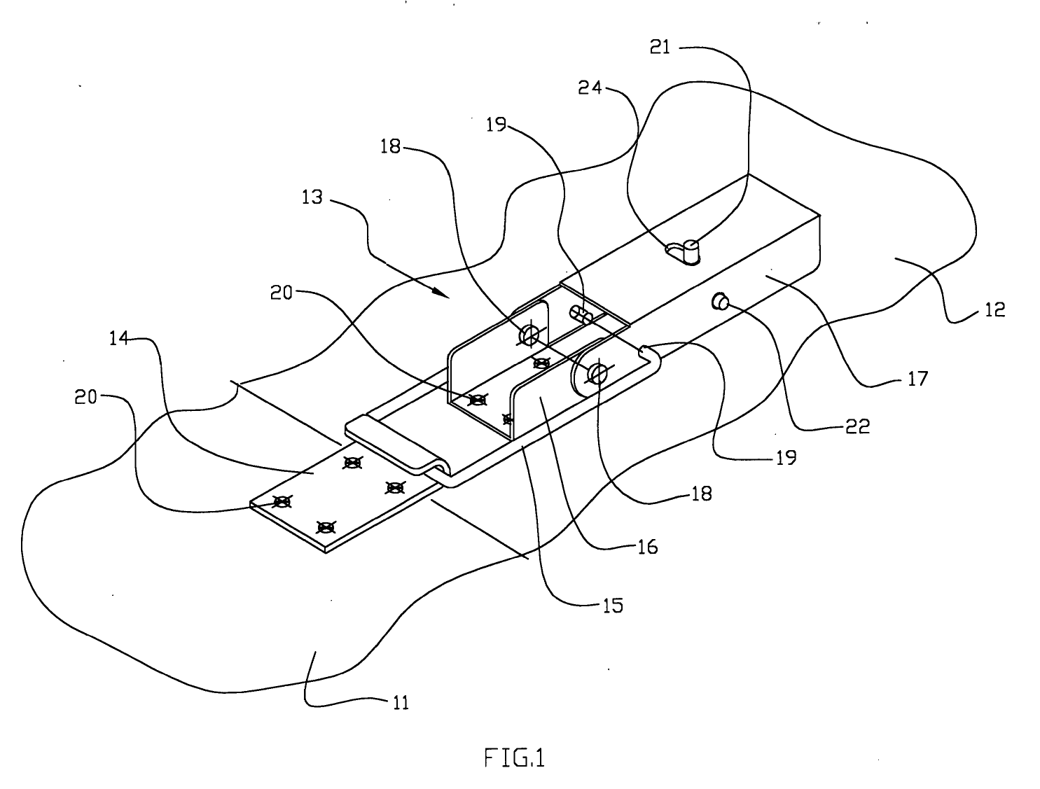

FIG. 1 Shows isometric view of the inventive latch in locked position with the safety catch in locked position.

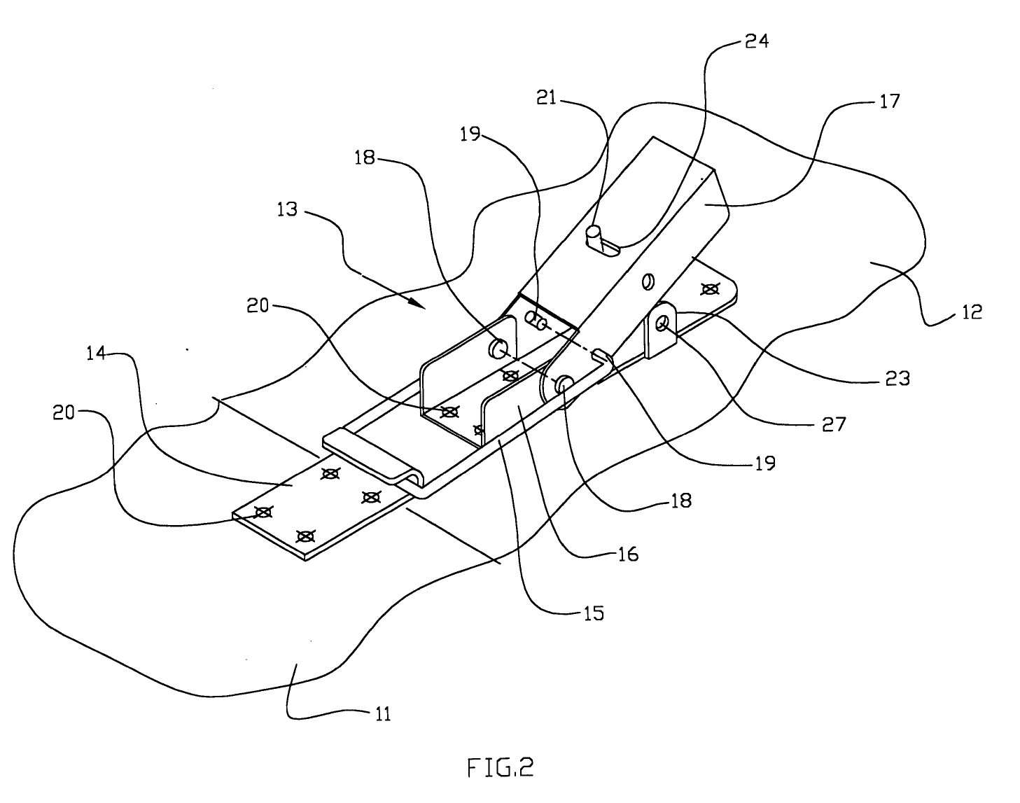

FIG. 2 Shows isometric view of the inventive latch with lifted lever and with safety catch in unlocked position.

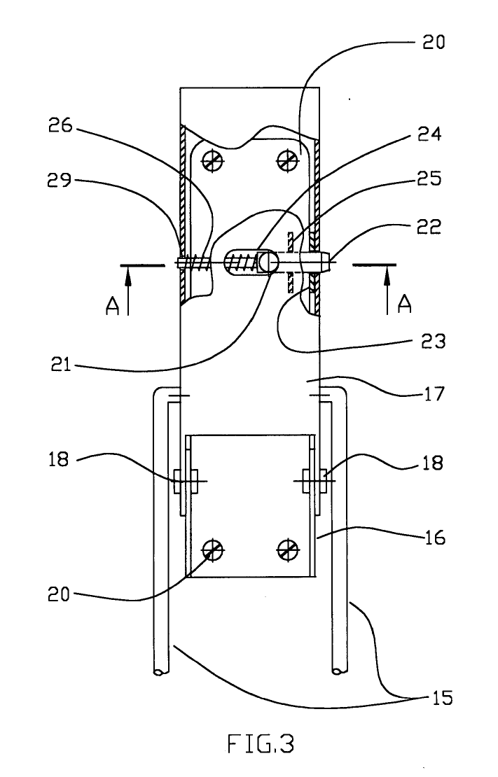

FIG. 3 Shows top view of the inventive latch in locked position.

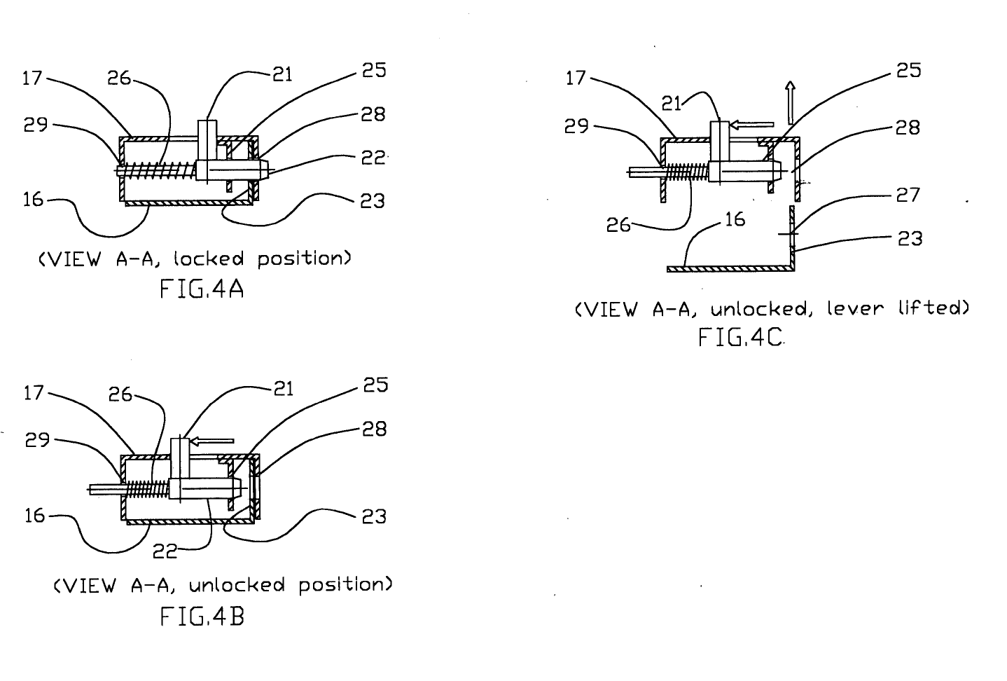

FIG. 4A Shows section A-A of the inventive latch showing the safety catch in locked position.

FIG. 4B Shows section A-A of the inventive latch showing the safety catch in unlocked position.

FIG. 4C Shows section A-A of the inventive latch showing the safety catch in unlocked position and the latch lever lifted.

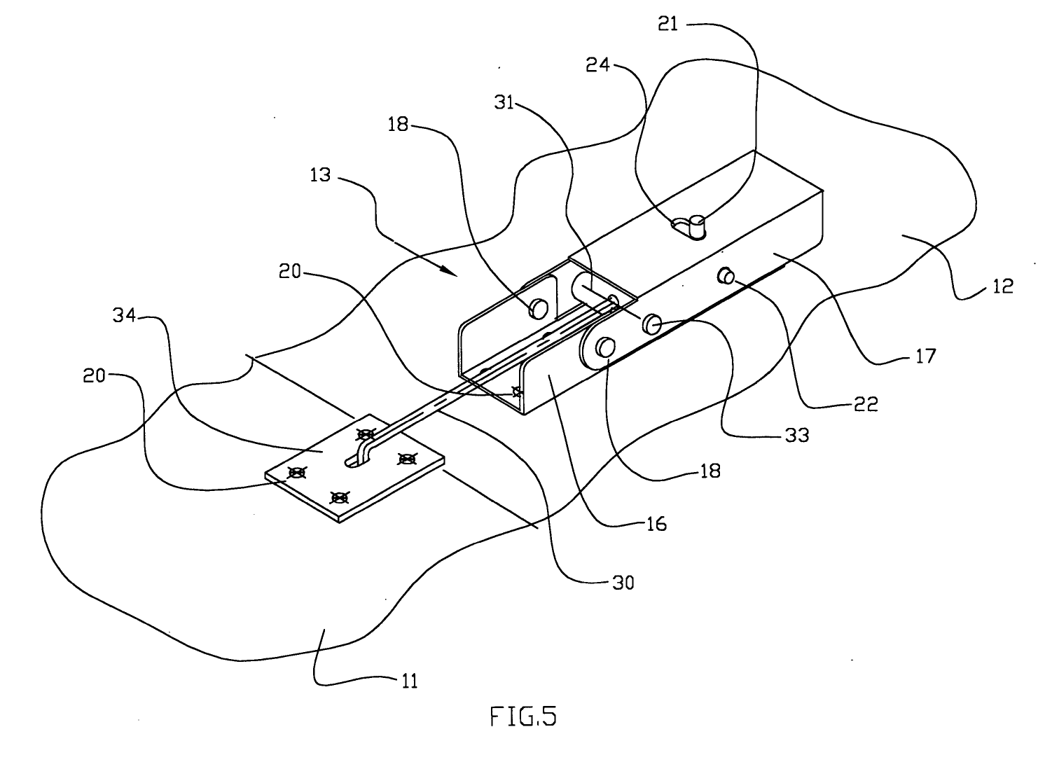

FIG. 5 Shows isometric view of the inventive latch equipped with adjustable length draw bar with hook style engaging end.

### REFERENCE NUMERALS

11—Fastened member
12—Fastened member
13—Inventive Draw Latch with the Safety Catch
14—Draw Plate with hook style edge
15—Latch loop style Draw Bar
16—Latch Base
17—Latch Lever
18—Latch lever Pivotal Connection Fastener
19—Loop type Draw bar Pivotal connection
20—Latch/draw plate Fastener
21—Latch safety catch Thumb Knob
22—Latch safety catch Bolt
23—Latch base Tab for engagement with the safety catch
24—Slide Slot in the latch lever for the safety catch thumb knob
25—Latch safety catch Bolt Support Bracket attached to the latch lever
26—Safety catch bolt Compression Spring
27—Latch base tab safety catch bolt Engagement Hole
28—Latch lever safety catch bolt Engagement Hole
29—Hole in the latch lever side wall to support the safety catch bolt
30—Latch Adjustable length Draw Bar with Hook style engaging end
31—Draw bar Pivotal Shaft
32—Draw bar Threaded Connection to the pivotal shaft
33—Pivotal shaft Fastener
34—Draw Plate with slot for draw bar engagement

### DETAILED DISCLOSURE OF PREFERRED EMBODIMENTS

Although specific features of the invention are shown in some drawings and not others, this is for convenience only as each feature may be combined with any or all of other features in accordance with the invention.

While preferred illustrative embodiments of the invention are described above, it will be apparent to those skilled in the art that various changes and modifications may be made without departing from the invention.

The appended claims are intended to cover all changes within the spirit of the invention. A preferred embodiment of the inventive draw latch is illustrated in FIGS. 1-5.

Referring now to FIG. 1, which is an isometric view of the inventive draw latch 13 fastening together two members 11 and 12. The latch is shown in closed position where the loop style draw bar 15 pulling the hook style edge of the draw plate 14 coupled to the member 11 and the base 16 of the latch is coupled to the member 12 by fasteners 20. Additionally, the latch comprised the lever 17 pivotally connected to said base 16 by two pivotal connection fasteners 18 arranged in coaxial way. One end of the draw bar 15 has pivotal connections 19 on both side walls of the latch lever 17 and arranged in coaxial way. Pivotal axis of said pivotal connections 19 is located at closer distance to the surface of said member 12 than pivotal axis of said lever fasteners 18 to provide toggle action for the latch.

Some elements of the inventive safety catch are shown on this drawing: the safety catch bolt 22 protruding through the side wall of the latch lever 17 the thumb knob 21 of the safety bolt is show in the slide slot 24.

Additional elements and the method of operation of the safety catch will be presented in the further drawings.

The FIG. 2 shows the same draw latch as described above, but in unlocked position. Said safety latch bolt thumb knob 21 has been moved to open position and the safety catch bolt has been disengaged from the hole 28 located on the side wall of latch lever 17 and from the hole 27 of the latch base tab 23 to allow the latch lever 17 to be lifted to release the draw bar 15 from the draw plate 14.

The partial plan view of the inventive draw latch is presented on FIG. 3. This drawing shows all elements of the safety catch: the latch safety catch bolt 22 supported by the side wall of the latch lever 17 (with hole 29) and the support bracket 25 attached to the latch lever, the thumb knob attached to the safety catch bolt 22 and protruding though the slot 24 on the latch lever 17, the compression spring 26 installed on said bolt 22, the latch base tab 23 with hole 27 for engagement with the safety latch bolt 22. Said above the bolt 22 supports are arranged to allow linear movement of the bolt 22 between locked and unlocked positions. The orientation of the safety catch bolt 22 is substantially parallel to the pivotal axis of the latch lever.

Section A-A on the drawing FIG. 3 allows more detailed description of the inventive safety catch on the following FIG. 4A through FIG. 4C.

FIG. 4A shows Section A-A view of the inventive draw latch with emphasis on the safety catch arrangement. The section A-A shows the safety catch in locked position with the safety catch bolt 22 engaging said latch base tab 23 and said latch lever hole 28 and protruding through this hole and insuring visual observation of the locked position, said compression spring 29 forcing said bolt 22 to remain in locked position.

The drawing shows that said safety catch bolt 22 can experience, practically, only shear stress in attempt to lift the latch lever 17, so this bolt design can withstand significant force and straight action of the compression spring 26 makes said bolt 22 engagement forceful and reliable, so, the whole safety catch concept is very simple and inexpensive to manufacture.

FIG. 4B shows Section A-A view of the safety catch in unlocked position with said safety catch bolt has been disengaged from said hole 28 of the latch lever 17 and from the hole 27 of said latch base tab 23, said spring 26 is compressed, said thumb knob 21 is in unlocked position being temporary supported in this position by an operator thumb.

FIG. 4C shows Section A-A view of the safety catch in unlocked position with said draw latch lever 17 has been lifted.

FIG. 5 presents isometric view of the inventive draw latch 13 equipped with the adjustable length draw bar 30 with hook style engaging end in locked position. Another end of said draw bar is attached to the pivotal shaft 31 by threaded connection 32 comprising matching mail thread on said draw bar 30 and female thread on said pivotal shaft 31. Said draw bar pivotal shaft 31 is pivotally attached to the draw latch lever 17 by two substantially coaxial oriented pivotal shaft fasteners 33. The hook end of the draw bar 30 is show being engaged with the draw plate 34.

Some elements of the latch described above, such as draw bars 15 and 30, draw plates 14 and 34, methods of adjustments of a draw bar to accommodate dimensional variations and general draw latch method of operation being of the usual conventional design, old in the art, and well known in structure and methods of operation to those skilled in the art, they are therefore simply indicated, and the details of structure and operation of them are omitted.

I claim:

1. A draw latch comprising a latch base, a latch lever pivotally connected the latch base, a draw bar pivotally connected to said latch lever, a draw plate for engagement with said draw bar, a safety catch comprising a safety catch bolt with a thumb knob, where said safety catch bolt is supported by one side wall of said latch lever and a bracket attached to said latch lever, a compression spring mounted on said safety catch bolt, a latch base tab with engagement hole and an engagement hole in the another side wall of the latch lever, where orientation of said safety catch bolt linear movement is substantially parallel to the pivotal axis of the latch lever, and when said latch lever is in locked position, said safety catch bolt being pushed by said compression spring into said engagement holes of the latch base tab and side wall of the latch lever and protruding trough said lever side wall, so, providing safety catching of the latch in the locked position, and further, with safety catch bolt being moved in unlocked position by pushing said thumb knob in the same direction, said safety catch bolt being disengaged from said engagement holes of the latch base tab and of the side wall of the latch lever allowing to move said latch lever into unlocked position.
